(19) United States
(12) Patent Application Publication
(10) Pub. No.: US 2026/0346666 A1
(43) Pub. Date: Nov. 5, 2026

(54) SUSPENSION ARM MEMBER AND METHOD FOR MANUFACTURING SUSPENSION ARM MEMBER

(71) Applicant: Resonac Corporation, Tokyo (JP)

(72) Inventors: Yoshifumi KIMURA, Tokyo (JP); Yoshiharu ABE, Tokyo (JP); Hidenori KOTAKI, Tokyo (JP)

(73) Assignee: Resonac Corporation, Tokyo (JP)

(21) Appl. No.: 19/486,994

(22) PCT Filed: Oct. 22, 2024
(86) PCT No.: PCT/JP2024/037625

§ 371 Date: Nov. 24, 2025

(30) Foreign Application Priority Data
Dec. 27, 2023 (JP) 2023-220737

(51) Int. Cl. B60G 7/00

(52) U.S. Cl. CPC B60G 7/001; B60G 2206/7102; B60G 2206/8101; B60G 2206/81022; B60G 2206/8106

(57) ABSTRACT

This suspension arm member is made of an aluminum alloy having an alloy composition containing Cu within a range of 0.2 mass % to 0.4 mass %, Mg within a range of 0.9 mass % to 1.2 mass %, Si within a range of 0.6 mass % to 0.9 mass %, Mn within a range of 0.05 mass % to 0.15 mass %, Fe within a range of 0.15 mass % to 0.30 mass %, Cr within a range of 0.2 mass % to 0.35 mass %, Ti within a range of 0.01 mass % to 0.05 mass %, and B within a range of 0.0010 mass % to 0.0050 mass %, with a remainder consisting of Al and inevitable impurities. A half value width of a diffraction peak of a Debye ring obtained by performing X-ray diffraction is 1.58° or larger.

### TECHNICAL FIELD

The present invention relates to a suspension arm member and a method for manufacturing a suspension arm member.

Priority is claimed on Japanese Patent Application No. 2023-220737, filed Dec. 27, 2023, the contents of which is incorporated herein by reference.

### BACKGROUND ART

In recent years, aluminum alloys have been widely used as structural members for various products, taking advantage of lightness thereof. For example, high-tensile steel has been used for suspension and bumper components of automobiles until now, but high-strength aluminum alloy material have recently come to be used. Iron-based materials have been mainly used for automobile components, for example, suspension components, but they are often replaced by aluminum materials or aluminum alloy materials, mainly for the purpose of weight reduction.

Since these automobile components require excellent corrosion resistance, high strength, and excellent processability, Al—Mg—Si-based alloys, particularly A6061, are often used as aluminum alloy materials. Further, in order to achieve improvement in strength, such automobile components are manufactured by forging, that is one kind of plastic processing, using aluminum alloy materials as materials for processing.

In addition, recently, due to the need to achieve cost down, suspension components obtained by forging cast members as raw materials as they stand without extrusion and then performing treatment, such as solution treatment and artificial aging treatment, (T6 treatment) have begun to be put into practical use. For the purpose of achieving further weight reduction, development of high-strength alloys substituting A6061 in the related art is underway (refer to Patent Documents 1 to 3).

### CITATION LIST

### Patent Documents

Patent Document 1: Japanese Unexamined Patent Application, First Publication No. H5-59477
Patent Document 2: Japanese Unexamined Patent Application, First Publication No. H5-247574
Patent Document 3: Japanese Unexamined Patent Application, First Publication No. H6-256880

### SUMMARY OF INVENTION

### Technical Problem

Recently, from the viewpoint of reduction in CO₂ emissions, demand for aluminum has tended to increase while seeking weight reduction of automobiles. However, a higher strength is required for alternatives of steel materials. It is important to control a crystal structure during forging in order to achieve a higher strength. For example, when forging is performed using an A6061 alloy, recovery behavior may be manifested in aluminum crystals through a solution treatment step to an aging treatment step after a forging step depending on conditions during the forging (forging material heating temperature, amount of equivalent strain), causing a problem of coarsening in the crystal structure.

Coarsening of a crystal structure may lead to fluctuation in mechanical characteristics, making it impossible to satisfy strength requirements of a member. The upper part (a) in FIG. 8 is an image diagram showing a state of an isotropic crystal structure consisting of a sufficient number of particles, and the lower part (b) in FIG. 8 shows a diffraction ring (Debye ring) obtained by performing X-ray diffraction with respect to the crystal structure in FIG. 8(a). In contrast, FIG. 9 is an image diagram when coarsening has occurred in a crystal structure. The upper part (a) in FIG. 9 is an image diagram showing a state where coarsening has occurred in some particles in a crystal structure consisting of a plurality of particles P, and the lower part (b) in FIG. 9 shows a diffraction ring (Debye ring) obtained by performing X-ray diffraction with respect to such a crystal structure as in FIG. 9(a). As shown in FIG. 9(b), in a crystal structure in which coarsening has occurred as in FIG. 9(a), the number of crystals contributing to diffraction is insufficient, and discontinuous bias occurs.

In addition, if orientation occurs in a crystal structure due to rolling or the like, grains become biased, and making it easier to observe biased diffraction rings. FIG. 10(a) is an image diagram showing a state where orientation has occurred in particles in a crystal structure consisting of a plurality of particles P, and FIG. 10(b) shows a diffraction ring (Debye ring) obtained by performing X-ray diffraction with respect to such a crystal structure as in FIG. 10(a).

In this manner, if X-ray diffraction is performed with respect to a crystal structure, diffraction rings (Debye rings) are usually obtained. However, recrystallization during forging may be unavoidable depending on the product shape, and it is considered that characteristics will become unstable if recrystallization occurs. Specifically, it is considered that strength characteristics will deteriorate if recrystallization occurs. In addition, it is said that it is difficult to obtain well-shaped diffraction rings (Debye rings) if a recrystallized structure is exhibited.

The present invention has been made in consideration of the foregoing circumstances, and an object thereof is to provide a high-strength suspension arm member having stable characteristics even if it exhibits a recrystallized structure.

### Solution to Problem

In order to resolve the foregoing problems, the present invention provides the following means.
[1] A suspension arm member according to an aspect of the present invention is made of an aluminum alloy having an alloy composition containing Cu within a range of 0.2 mass % to 0.4 mass %, Mg within a range of 0.9 mass % to 1.2 mass %, Si within a range of 0.6 mass % to 0.9 mass %, Mn within a range of 0.05 mass % to 0.15 mass %, Fe within a range of 0.15 mass % to 0.30 mass %, Cr within a range of 0.2 mass % to 0.35 mass %, Ti within a range of 0.01 mass % to 0.05 mass %, and B within a range of 0.0010 mass % to 0.0050 mass %, with a remainder consisting of Al and inevitable impurities. A half value width of a diffraction peak of a Debye ring obtained by performing X-ray diffraction is 1.58° or larger.
[2] The suspension arm member according to the foregoing [1] may include a wheel-side joint portion, a first vehicle body-side joint portion, a second vehicle body-side joint portion, a first arm portion connecting the wheel-side joint portion and the first vehicle body-side joint portion, and a second arm portion connecting the wheel-side joint portion and the second vehicle body-side joint portion. The first arm portion may be longer than the second arm portion. The half value width may be a half value width of a diffraction peak of a Debye ring obtained by performing X-ray diffraction with respect to the first arm portion. A 0.2% yield strength may be 300 MPa or greater.
[3] A method for manufacturing a suspension arm member according to another aspect of the present invention has a molten metal forming step of obtaining a molten alloy having an alloy composition containing Cu within a range of 0.2 mass % to 0.4 mass %, Mg within a range of 0.9 mass % to 1.2 mass %, Si within a range of 0.6 mass % to 0.9 mass %, Mn within a range of 0.05 mass % to 0.15 mass %, Fe within a range of 0.15 mass % to 0.30 mass %, Cr within a range of 0.2 mass % to 0.35 mass %, Ti within a range of 0.01 mass % to 0.05 mass %, and B within a range of 0.0010 mass % to 0.0050 mass %, with a remainder consisting of Al and inevitable impurities; a casting step of obtaining a cast product by casting the obtained molten metal; a forging step of obtaining a forged product by forging the cast product at a temperature of 470 °C to 500 °C; a solution treatment step of holding the forged product at a temperature of 500 °C or higher; a water quenching step of performing water quenching of the forged product after solution treatment; and an aging treatment step of performing heat treatment of a forged product that has gone through the water quenching step.
[4] In the method for manufacturing a suspension arm member according to the foregoing [3], in the solution treatment step, the forged product may be held at a temperature of 530 °C to 560 °C for 0.3 hours to three hours. In the water quenching step, water quenching may be performed using water at 60 °C or lower. In the aging treatment step, a forged product that has gone through the water quenching step may be heated at a temperature of 170 °C to 220 °C for 0.5 hours to 7.0 hours.
[5] In the method for manufacturing a suspension arm member according to the foregoing [3] or [4], the casting step may be performed by continuous casting. In the aging treatment step, a forged product that has gone through the water quenching step may be heated at a temperature of 175 °C to 190 °C for four hours or longer.

### Advantageous Effects of Invention

According to the present invention, it is possible to provide a high-strength suspension arm member having stable characteristics even if it exhibits a recrystallized structure.

### BRIEF DESCRIPTION OF DRAWINGS

FIG. 1 A plan view showing an example of a constitution of a suspension arm member according to an aspect of the present invention.

FIG. 2 A cross-sectional view of the suspension arm member in FIG. 1 taken along cutting line A-A′.

FIG. 3 A cross-sectional view showing an example of a constitution near a casting mold of a horizontal continuous casting apparatus which can be used in a casting step of a method for manufacturing a suspension arm member according to another aspect of the present invention.

FIG. 4 An enlarged cross-sectional view of a main part near a cooling water cavity of the horizontal continuous casting apparatus in FIG. 3.

FIG. 5 An explanatory view of a heat flux of a cooling wall portion of the horizontal continuous casting apparatus.

FIG. 6 An X-ray diffraction result with respect to a first arm portion of the suspension arm member in Example 1.

FIG. 7 Analysis results of diffraction intensities in the vicinity of a diffraction peak of a Debye ring in the X-ray diffraction result in FIG. 6.

FIG. 8 An image diagram showing a state of an isotropic crystal structure consisting of a sufficient number of particles, and a diffraction ring (Debye ring) obtained by performing X-ray diffraction with respect to such a crystal structure.

FIG. 9 An image diagram showing a state where coarsening has occurred in some particles in a crystal structure consisting of a plurality of particles P, and a diffraction ring (Debye ring) obtained by performing X-ray diffraction with respect to such a crystal structure.

FIG. 10 An image diagram showing a state where orientation has occurred in particles in a crystal structure consisting of a plurality of particles P, and a diffraction ring (Debye ring) obtained by performing X-ray diffraction with respect to such a crystal structure.

### DESCRIPTION OF EMBODIMENTS

Hereinafter, an embodiment of the present invention will be described in detail with reference to the drawings.

In the drawings used in the following description, in order to make characteristics easy to understand, characteristic parts may be shown in an enlarged manner for the sake of convenience, and dimensional ratios or the like of each constituent element are not always the same as actual values thereof. In addition, materials, dimensions, and the like exemplified in the following description are merely examples. The present invention is not necessarily limited to them, and can be suitably changed and performed within a range in which the gist thereof is not changed.

### [Suspension Arm Member]

First, a suspension arm member according to the embodiment of the present invention will be described.

The suspension arm member according to the embodiment of the present invention is an aluminum alloy forged product and is a member for a suspension arm.

The aluminum alloy forged product of the present embodiment is made of an aluminum alloy having an alloy composition containing Cu within a range of 0.2 mass % to 0.4 mass %, Mg within a range of 0.9 mass % to 1.2 mass %, Si within a range of 0.6 mass % to 0.9 mass %, Mn within a range of 0.05 mass % to 0.15 mass %, Fe within a range of 0.15 mass % to 0.30 mass %, Cr within a range of 0.2 mass % to 0.35 mass %, Ti within a range of 0.01 mass % to 0.05 mass %, and B within a range of 0.0010 mass % to 0.0050 mass %, with a remainder consisting of Al and inevitable impurities.

The aluminum alloy forged product of the present embodiment corresponds to a 6000-series aluminum alloy forged product in containing Mg and Si.

In the suspension arm member according to the embodiment of the present invention, the half value width in the diffraction peak of a Debye ring obtained by performing X-ray diffraction is 1.58° or larger.

### (Cu: 0.2 Mass % to 0.4 Mass %)

Cu has an effect of finely dispersing Mg—Si-based compounds in an aluminum alloy, and an effect of improving the tensile strength of an aluminum alloy by precipitating as Al—Cu—Mg—Si-based compounds including a Q phase. The Cu content is within a range of 0.20 mass % to 0.40 mass % and may be within a range of 0.25 mass % to 0.35 mass % or 0.30 mass % or more. With the Cu content being within the foregoing range, the mechanical characteristics of the aluminum alloy forged product at room temperature can be improved.

### (Mg: 0.9 Mass % to 1.2 Mass %)

Mg has an effect of improving the tensile strength of an aluminum alloy. Mg contributes to strengthening of an aluminum alloy by forming a solid solution in an aluminum matrix or by precipitating as Mg—Si-based compounds (Mg₂Si) such as a β″ phase or Al—Cu—Mg—Si-based compounds including the Q phase. The Mg content is within a range of 0.90 mass % to 1.20 mass % and may be within a range of 0.95 mass % to 1.10 mass % or 1.00 mass % to 1.05 mass %. With the Mg content being within the foregoing range, corrosion resistance as well as the mechanical characteristics of the aluminum alloy forged product at room temperature can be improved.

### (Si: 0.6 Mass % to 0.9 Mass %)

Similar to Mg, Si has an effect of improving the corrosion resistance as well as the mechanical characteristics of the aluminum alloy forged product at room temperature. However, if Si is excessively added to an aluminum alloy, coarse primary Si grains may be crystallized, and there is concern that the tensile strength of the aluminum alloy may deteriorate. The Si content is within a range of 0.60 mass % to 0.90 mass % and may be within a range of 0.65 mass % to 0.85 mass % or 0.70 mass % to 0.80 mass %. With the Si content being within the foregoing range, while crystallization of primary Si is curbed, the corrosion resistance can be improved as well as the mechanical characteristics of the aluminum alloy forged product at room temperature.

### (Mn: 0.05 Mass % to 0.15 Mass %)

Mn has an effect of improving the tensile strength of an aluminum alloy by forming fine granular crystallized products containing intermetallic compounds such as Al—Mn—Fe—Si or Al—Mn—Cr—Fe—Si in the aluminum alloy. The Mn content is within a range of 0.05 mass % to 0.15 mass % and may be within a range of 0.07 mass % to 0.14 mass % or 0.10 mass % to 0.13 mass %. With the Mn content being within the foregoing range, the mechanical characteristics of the aluminum alloy forged product at room temperature can be improved.

### (Fe: 0.15 Mass % to 0.3 Mass %)

Fe has an effect of improving the tensile strength of an aluminum alloy by being crystallized as fine crystallized products containing intermetallic compounds such as Al—Mn—Fe—Si, Al—Mn—Cr—Fe—Si, Al—Fe—Si, Al—Cu—Fe, or Al—Mn—Fe in the aluminum alloy. The Fe content is within a range of 0.15 mass % to 0.30 mass % and may be within a range of 0.20 mass % to 0.27 mass % or 0.22 mass % or more. With the Fe content being within the foregoing range, the mechanical characteristics of the aluminum alloy forged product at room temperature can be improved.

### (Cr: 0.2 Mass % to 0.35 Mass %)

Cr has an effect of improving the tensile strength of an aluminum alloy by forming fine granular crystallized products containing intermetallic compounds such as Al—Mn—Cr—Fe—Si or Al—Fe—Cr in the aluminum alloy. The Cr content is within a range of 0.20 mass % to 0.35 mass % and may be within a range of 0.21 mass % to 0.30 mass % or 0.25 mass % or less. With the Cr content being within the foregoing range, the mechanical characteristics of the aluminum alloy forged product at room temperature can be improved.

### (Ti: 0.01 Mass % to 0.05 Mass %)

Ti has an effect of refining crystal grains of an aluminum alloy and improving the stretchability. When the Ti content is less than 0.01 mass %, there is concern that the effect of refining crystal grains may not be sufficiently achieved. Meanwhile, if the Ti content exceeds 0.05 mass %, there is concern that coarse crystallized products may be formed so that the stretchability may deteriorate. In addition, if a large amount of coarse crystallized products containing Ti is mixed into the aluminum alloy forged product, the toughness may deteriorate. Therefore, the Ti content is set to 0.010 mass % to 0.050 mass %. The Ti content is preferably 0.015 mass % to 0.030 mass %.

### (B: 0.0010 Mass % to 0.0050 Mass %)

B has an effect of refining crystal grains of an aluminum alloy and improving the stretchability. The effect of refining crystal grains is improved by adding B together with Ti described above to an aluminum alloy. When the B content is less than 0.001 mass %, there is concern that the effect of refining crystal grains may not be sufficiently achieved. Meanwhile, if the B content exceeds 0.0050 mass %, there is concern that coarse crystallized products may be formed and mixed into the aluminum alloy forged product as an inclusion. In addition, if a large amount of coarse crystallized products containing B is mixed into a final product of an aluminum alloy, the toughness may deteriorate. Therefore, the B content is set to 0.0010 to 0.0050 mass %. The B content is preferably 0.0015 to 0.045 mass %.

### (Inevitable Impurities)

Inevitable impurities are impurities which are inevitably mixed into an aluminum alloy from raw materials of the aluminum alloy forged product or a manufacturing step. Examples of inevitable impurities include Zn, Zr, Ni, Sn, and Be. It is preferable that the inevitable impurity content does not exceed 0.10 mass %, that is, be 0.10 mass % or less.

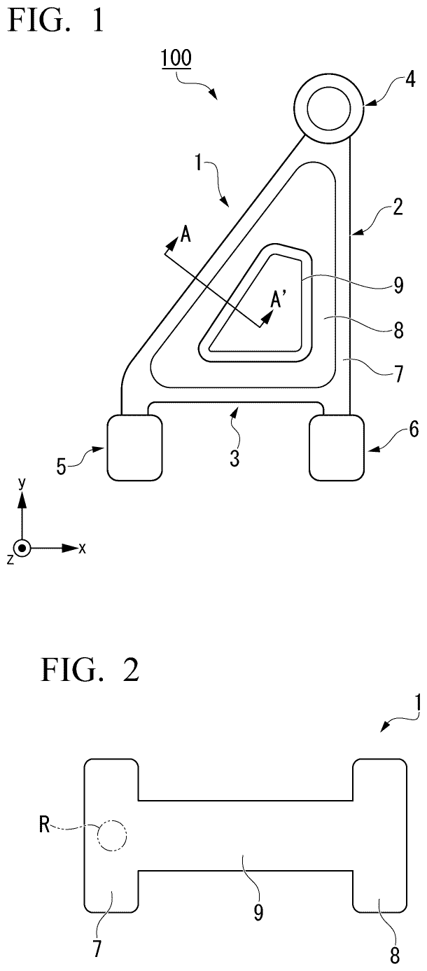

FIG. 1 is a plan view showing an example of a constitution of a suspension arm member according to an aspect of the present invention, and FIG. 2 is a cross-sectional view of the suspension arm member in FIG. 1 taken along cutting line A-A′. A suspension arm member 100 shown in FIGS. 1 and 2 is a member for a suspension arm, which is referred to as an A-type arm, an A arm, an A-shaped suspension arm, or the like. In a suspension arm member, there are cases where holes are drilled into a part of a forged product for final attachment to other members such as a vehicle body and wheels, but the suspension arm member may be a member after drilling or a forged product before drilling.

For example, the suspension arm member 100 shown in FIGS. 1 and 2 includes a wheel-side joint portion 4, a first vehicle body-side joint portion 5, a second vehicle body-side joint portion 6, a first arm portion 1 connecting the wheel-side joint portion 4 and the first vehicle body-side joint portion 5, a second arm portion 2 connecting the wheel-side joint portion 4 and the second vehicle body-side joint portion 6, and an arm joint portion 3 connecting the first vehicle body-side joint portion 5 and the second vehicle body-side joint portion 6. In the suspension arm member 100, the first arm portion 1 is longer than the second arm portion 2. That is, in the suspension arm member formed by forging, the first arm portion 1 can be said to be a member having a higher processing rate than the second arm portion 2. The processing rate (%) increases as change in size of the cross-sectional area of the material before and after the processing increases, and is calculated using the following Expression (1).

100×(A₀−A)/A₀ (1)
(in Expression (1), A₀: the cross-sectional area of the material before processing, A: the cross-sectional area of the material after processing)

In addition, even if the cross-sectional area of the material before processing is unknown, the processing rate can be estimated from the shape of the suspension by reverse analysis such as simulation.

As described above, FIG. 2 is a cross-sectional view of the suspension arm member in FIG. 1 taken along cutting line A-A′. In addition, the cutting line A-A′ indicates a cross section passing through middle points of the wheel-side joint portion 4 and the first vehicle body-side joint portion 5. As shown in the cross section of the first arm portion 1 in FIG. 2, for example, each of the first arm portion 1, the second arm portion 2, and the arm joint portion 3 has an outer circumferential portion 7 constituting the external shape of the suspension arm member 100A, an inner circumferential portion 8 close to a region where an opening is formed in a plan view, and a recessed portion 9 positioned between the outer circumferential portion 7 and the inner circumferential portion 8. For example, the recessed portion 9 is a region recessed in a z direction with respect to the outer circumferential portion 7 and the inner circumferential portion 8.

In the suspension arm member 100 according to the embodiment of the present invention, the half value width in the diffraction peak of a Debye ring obtained by performing X-ray diffraction with respect to a portion having a high processing rate is 1.58° or larger. In the suspension arm member 100 shown in FIG. 1, the region having a high processing rate is a region positioned in the outer circumferential portion 7 in a cross section taken along cutting line A-A′ in the first arm portion 1, and is a region corresponding to the reference sign R indicated by the two-dot dashed line in FIG. 2. The region corresponding to the reference sign R corresponds to the intersection of the center of the outer circumferential portion 7 in the width direction and the center thereof in the thickness direction. In the suspension arm member according to the embodiment of the present invention, the half-value width in the diffraction peak obtained by performing X-ray diffraction with respect to the region indicated by the reference sign R in FIG. 2 is 1.58 or larger.

When X-ray diffraction is performed using a polycrystalline metal material, diffracted rays are generated from crystal planes satisfying Bragg reflection conditions with respect to incident X-rays. Cone-shaped Debye rings having the incident X-rays as their axis are obtained from these diffracted X-rays.

The shape of a Debye ring is affected by the crystal structure of a metal, and a Debye ring having a diffraction peak with a stronger intensity is obtained as crystals are finer and more uniform. Meanwhile, if crystals are coarse, a well-shaped Debye ring cannot be obtained.

In a member exhibiting recrystallization, the Debye rings are often not able to be obtained in a well-shaped manner, but the state of the member can be ascertained from the locally obtained diffraction peak. Particularly, the inventor has found that the half value width in the diffraction peak has a correlation with the mechanical characteristics of the member.

In addition, for example, in the suspension arm member 100, the 0.2% yield strength conforming to JIS Z2241: 2011 is 300 MPa or greater, is preferably 302 MPa or greater, and is more preferably 304 MPa or greater.

FIGS. 1 and 2 show an example in which the suspension arm member is an A-type arm including the first arm portion 1, the second arm portion 2, and the arm joint portion 3. However, the present invention is not limited to the foregoing example and is also applied to suspension arm members having other shapes. In suspension arm members having other shapes, the half value width in the diffraction peak of a Debye ring obtained by performing X-ray diffraction in a portion considered to have the highest processing rate may be 1.58° or larger.

### [Method for Manufacturing Suspension Arm Member]

Next, a method for manufacturing the foregoing suspension arm member will be described.

The method for manufacturing the suspension arm member according to the embodiment of the present invention has a molten metal forming step of obtaining a molten alloy having the same composition as the foregoing aluminum alloy forged product, a casting step of obtaining a cast product by casting the molten alloy, a forging step of obtaining a forged product by forging the obtained cast product at a temperature of 470 °C to 500 °C, a solution treatment step of heating the forged product at a temperature of 500 °C or higher, a water quenching step of performing water quenching of the forged product after solution treatment, and an aging treatment step of performing heat treatment of a forged product that has gone through the water quenching step.

The method for manufacturing the suspension arm member according to the embodiment of the present invention has, for example, the molten metal forming step, the casting step, the forging step, the solution treatment step, the quenching treatment step and the aging treatment step.

### (Molten Metal Forming Step)

The molten metal forming step is a step in which a composition is prepared by melting raw materials to obtain a molten aluminum alloy. The composition of the molten aluminum alloy is adjusted to become an alloy composition containing Cu within a range of 0.2 mass % to 0.4 mass %, Mg within a range of 0.9 mass % to 1.2 mass %, Si within a range of 0.6 mass % to 0.9 mass %, Mn within a range of 0.05 mass % to 0.15 mass %, Fe within a range of 0.15 mass % to 0.30 mass %, Cr within a range of 0.2 mass % to 0.35 mass %, Ti within a range of 0.01 mass % to 0.05 mass %, and B within a range of 0.0010 mass % to 0.0050 mass %, with a remainder consisting of Al and inevitable impurities. The composition of the molten aluminum alloy corresponds to the composition of the aluminum alloy of the suspension arm member according to the foregoing embodiment.

By performing subsequent steps using a molten aluminum alloy having a foregoing composition, it is possible to provide a suspension arm member having stable characteristics even if it exhibits a recrystallized structure. Virgin aluminum is aluminum having a concentration of 99% or higher obtained by performing electrolysis, which is referred to as electrolytic refining, with respect to alumina manufactured from minerals.

A molten aluminum alloy can be obtained by heating and melting an aluminum alloy. In addition, it may be molded by melting a mixture containing a single element or a compound containing two or more kinds of elements which become the raw materials of an aluminum alloy in ratios for generating an objective aluminum alloy. For example, Ti and B may be mixed into it as crystal grain refining materials such as Al—Ti—B rods for the purpose of controlling the crystal grain size of an aluminum alloy generated in the casting step.

In addition, using 10% or more of a scrap material of an aluminum alloy of 1000 series, 2000 series, 3000 series, 4000 series, 5000 series, 6000 series, or 7000 series used as raw materials for a molten aluminum alloy with the remainder of virgin aluminum and the foregoing added elements, a molten aluminum alloy in which the composition is prepared by melting these may be obtained. In this case, an Al—Mg—Si-based suspension arm member in which recrystallization is unlikely to occur and which has excellent mechanical characteristics at room temperature can be obtained. Virgin aluminum is aluminum having a purity of 99% or higher, for example, obtained by performing electrolysis, which is referred to as electrolytic refining, with respect to alumina manufactured from minerals.

### (Casting Step)

In the casting step, a molten aluminum alloy (liquid phase) is cooled and is coagulated into a solid (solid phase) to obtain an aluminum alloy cast product. The casting step is preferably performed by continuous casting. For example, a vertical continuous casting method or a horizontal continuous casting method can be used for the casting step. Hereinafter, with an example of a case where the casting step is performed by the horizontal-type continuous casting method, the method for manufacturing the suspension arm member according to the embodiment of the present invention will be described.

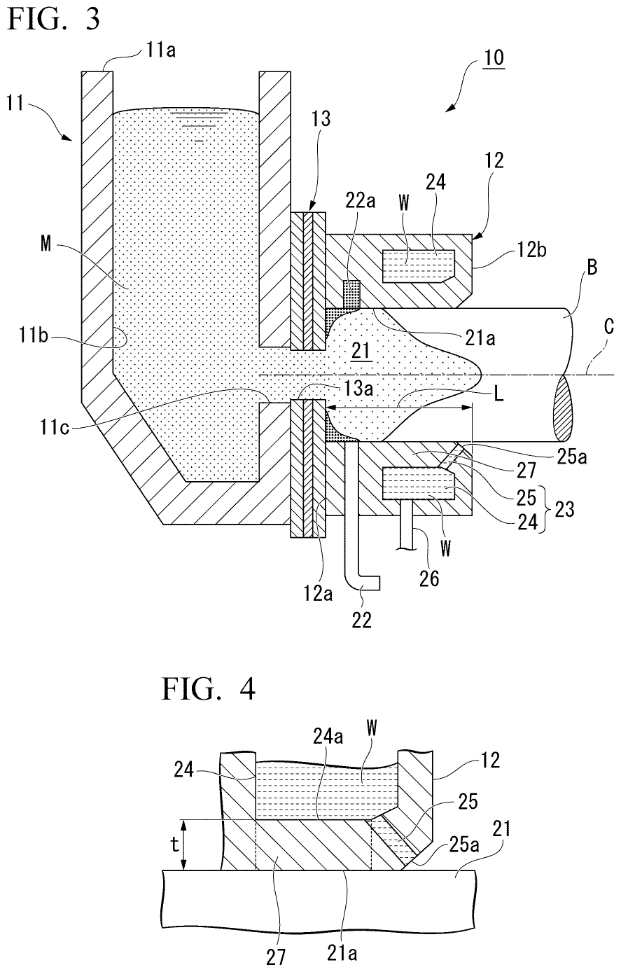

FIGS. 3 and 4 show a horizontal continuous casting apparatus which can be used for manufacturing the aluminum alloy cast product of the present embodiment. FIG. 3 is a cross-sectional view showing an example of a part near a casting mold 12 of a horizontal continuous casting apparatus 10. FIG. 4 is an enlarged cross-sectional view of a main part near a cooling water cavity 24 of the horizontal continuous casting apparatus 10.

The horizontal continuous casting apparatus 10 shown in FIGS. 3 and 4 has a molten metal reception portion (tundish) 11, the hollow cylindrical casting mold 12, and a refractory plate-shaped body (heat insulating member) 13 disposed between one end side 12a of this casting mold 12 and the molten metal reception portion 11.

The molten metal reception portion 11 is constituted of a molten metal inflow portion 11a for receiving a molten aluminum alloy M obtained in the foregoing molten metal forming step, a molten metal holding portion 11b, and an outflow portion 11c to a hollow portion 21 of the casting mold 12.

The molten metal reception portion 11 maintains the upper liquid level of the molten aluminum alloy M at a position higher than the upper surface of the hollow portion 21 of the casting mold 12, and stably distributes the molten aluminum alloy M to each casting mold 12 in the case of multiple casting.

The molten aluminum alloy M held in the molten metal holding portion 11b inside the molten metal reception portion 11 is poured into the hollow portion 21 of the casting mold 12 through a pouring passage 13a provided in the refractory plate-shaped body 13. Further, the molten aluminum alloy M supplied to the inside of the hollow portion 21 is cooled and solidified by a cooling device 23 (which will be described below) and is drawn out from the other end side 12b of the casting mold 12 as an aluminum alloy rod B (coagulated ingot).

A drawer drive device (not shown) drawing out the cast aluminum alloy rod B at a constant speed may be installed on the other end side 12b of the casting mold 12. In addition, it is also preferable that a synchronized cutting machine (not shown) for cutting the continuously drawn aluminum alloy rod B to any desired length be installed.

The refractory plate-shaped body 13 is a member blocking heat transfer between the molten metal reception portion 11 and the casting mold 12, and it may be constituted using a material such as calcium silicate, alumina, silica, a mixture of alumina and silica, silicon nitride, silicon carbide, or graphite, for example. Such a refractory plate-shaped body 13 can also be constituted of a plurality of layers made of constituent materials different from each other.

In the present embodiment, the casting mold 12 is a hollow cylindrical member, which is formed of one or a combination of two or more kinds of materials selected from aluminum, copper, or alloys thereof, for example. The material of such a casting mold 12 may be selected from an optimum combination in terms of thermal conductivity, heat resistance, and mechanical strength.

The hollow portion 21 of the casting mold 12 is formed to have a circular cross section in order to cast the aluminum alloy rod B into a cylindrical rod shape, and the casting mold 12 is held such that a casting mold center axis (center axis) C passing through the center of this hollow portion 21 lies almost in the horizontal direction.

An inner circumferential surface 21a of the hollow portion 21 of the casting mold 12 is formed at an elevation angle of 0° to 3° (more preferably 0° to 1°) with respect to the casting mold center axis C in the casting direction (refer to FIG. 3) of the aluminum alloy rod B. That is, the inner circumferential surface 21a is constituted to have a tapered shape which opens conically in the casting direction. Further, the angle formed by the taper is the elevation angle.

If the elevation angle is smaller than 0°, there is concern that casting may become difficult due to a resistance received on the other end side 12b (casting mold exit) when the aluminum alloy rod B is drawn out from the casting mold 12. Meanwhile, if the elevation angle exceeds 3°, contact of the inner circumferential surface 21a with the molten aluminum alloy M becomes insufficient, and there is concern that coagulation becomes insufficient due to deterioration in the effect of releasing heat from the molten aluminum alloy M or a coagulated shell, in which it is cooled and solidified, to the casting mold 12. As a result, there is concern that it may lead to a casting problem such as a remelted skin generated on the surface of the aluminum alloy rod B or eruption of the uncoagulated molten aluminum alloy M from an end portion of the aluminum alloy rod B, which is not preferable.

The cross-sectional shape of the hollow portion 21 of the casting mold 12 (the planar shape of the hollow portion 21 of the casting mold 12 when viewed from the other end side 21b) may be selected in accordance with the shape of an aluminum alloy rod to be cast, for example, a triangular or rectangular cross-sectional shape, a polygonal shape, a semicircular shape, an elliptical shape, or an irregular cross-sectional shape having no axis or plane of symmetry, in addition to the circular shape of the present embodiment.

A fluid supply pipe 22 for supplying a lubricating fluid to the inside of the hollow portion 21 of the casting mold 12 is disposed on the one end side 12a of the casting mold 12. Any one or two or more kinds of lubricating fluids selected from a gas lubricant and a liquid lubricant can be adopted as the lubricating fluid supplied through the fluid supply pipe 22. When both a gas lubricant and a liquid lubricant are supplied, it is preferable to provide separate fluid supply pipes. The lubricating fluid supplied under pressure through the fluid supply pipe 22 is supplied to the inside of the hollow portion 21 of the casting mold 12 through an annular lubricant supply port 22a.

In the present embodiment, a lubricating fluid fed under pressure is supplied to the inner circumferential surface 21a of the casting mold 12 from the lubricant supply port 22a. A constitution in which a liquid lubricant is heated to become a decomposed gas and supplied to the inner circumferential surface 21a of the casting mold 12 may be adopted. In addition, a constitution in which a porous material is disposed in the lubricant supply port 22a and a lubricating fluid seeps out to the inner circumferential surface 21a of the casting mold 12 via this porous material may be adopted.

The cooling device 23, which is a cooling means for cooling and solidifying the molten aluminum alloy M, is formed inside the casting mold 12. The cooling device 23 of the present embodiment has the cooling water cavity 24 which accommodates cooling water W for cooling the inner circumferential surface 21a of the hollow portion 21 of the casting mold 12, and a cooling water injection passage 25 through which this cooling water cavity 24 and the hollow portion 21 of the casting mold 12 communicate with each other.

The cooling water cavity 24 is annularly formed so as to surround the hollow portion 21 on the outward side of the inner circumferential surface 21a of the hollow portion 21 inside the casting mold 12, and the cooling water W is supplied via a cooling water supply pipe 26.

In the casting mold 12, the inner circumferential surface 21a is cooled by the cooling water W accommodated in the cooling water cavity 24 so that heat of the molten aluminum alloy M filling the inside of the hollow portion 21 of the casting mold 12 is taken away from the surface in contact with the inner circumferential surface 21a of the casting mold 12, and therefore a coagulated shell is formed on the surface of the molten aluminum alloy M.

In addition, the cooling water injection passage 25 cools the aluminum alloy rod B by directly applying the cooling water W through a shower opening 25a facing the hollow portion 21 toward the aluminum alloy rod B on the other end side 12b of the casting mold 12. The vertical cross-sectional shape of such a cooling water injection passage 25 may be a semicircular shape, a pear shape, or a horseshoe shape, for example, in addition to the circular shape of the present embodiment.

In the present embodiment, the cooling water W supplied via the cooling water supply pipe 26 is first accommodated in the cooling water cavity 24 to cool the inner circumferential surface 21a of the hollow portion 21 of the casting mold 12, and the cooling water W in the cooling water cavity 24 is further injected toward the aluminum alloy rod B through the cooling water injection passage 25. However, these may also be constituted to be supplied by cooling water supply pipes of separate systems.

The length from the position where the extension line of the center axis of the shower opening 25a of the cooling water injection passage 25 hits the surface of the cast aluminum alloy rod B to a contact surface between the casting mold 12 and the refractory plate-shaped body 13 will be referred to as an effective mold length L, and this effective mold length L is preferably 10 mm to 40 mm, for example. If this effective mold length L is shorter than 10 mm, casting cannot be performed because no favorable coating can be formed or the like. If it exceeds 40 mm, the effect of forced cooling may be reduced, coagulation by a casting mold wall may become dominant, and the contact resistance between the casting mold 12 and the molten aluminum alloy M or the aluminum alloy rod B may increase. Therefore, it is not preferable because there is concern that casting may become unstable due to cracking occurring on a casting surface, a tear occurring inside the casting mold, or the like.

Regarding supply of the cooling water cavity 24 to the cooling water W and injection of the cooling water W from the shower opening 25a of the cooling water injection passage 25, it is preferable that each operation be able to be controlled by control signals from a control device (not shown).

The cooling water cavity 24 is formed such that an inner bottom surface 24a near the hollow portion 21 of the casting mold 12 becomes a surface parallel to the inner circumferential surface 21a of the hollow portion 21 of the casting mold 12.

Here, the term “parallel” includes a case where the inner circumferential surface 21a of the hollow portion 21 of the casting mold 12 is formed at an elevation angle of 0° to 3° with respect to the inner bottom surface 24a of the cooling water cavity 24, that is, a case where the inner bottom surface 24a is inclined at an angle exceeding 0° up to 3° with respect to the inner circumferential surface 21a.

As shown in FIG. 4, such a cooling wall portion 27 of the casting mold 12, which is a part where the inner bottom surface 24a of the cooling water cavity 24 and the inner circumferential surface 21a of the hollow portion 21 of the casting mold 12 face each other, is formed such that the heat flux value per unit area from the molten aluminum alloy M in the hollow portion 21 toward the cooling water W in the cooling water cavity 24 is within a range of 10×10⁵ W/m² to 50×10⁵ W/m².

The casting mold 12 may be formed such that a thickness t of the cooling wall portion 27 of the casting mold 12, that is, a gap between the inner bottom surface 24a of the cooling water cavity 24 and the inner circumferential surface 21a of the hollow portion 21 of the casting mold 12 is within a range of, for example, 0.5 mm to 3.0 mm, preferably 0.5 mm to 2.5 mm. In addition, the material for forming the casting mold 12 may be selected such that at least the thermal conductivity of the cooling wall portion 27 of the casting mold 12 is within a range of 100 W/m·K to 400 W/m·K.

In FIG. 4, the molten aluminum alloy M in the molten metal reception portion 11 is supplied through the refractory plate-shaped body 13 from the one end side 12a of the casting mold 12, which is held such that the casting mold center axis C becomes almost horizontal, and it is forcibly cooled on the other end side 12b of the casting mold 12 and becomes the aluminum alloy rod B.

Since the aluminum alloy rod B is drawn out at a constant speed by the drawer drive device (not shown) installed near the other end side 12b of the casting mold 12, it is continuously cast and a long aluminum alloy rod B is formed. The drawn aluminum alloy rod B is cut to a desired length by a synchronized cutting machine (not shown), for example.

For example, the composition ratio of the cast aluminum alloy rod B can be confirmed by a method using a photoelectric photometric emission spectroscopic analysis device (device example: PDA-5500 manufactured by Shimadzu Corporation, Japan) specified in “JIS H 1305”.

The difference between the height of the liquid level of the molten aluminum alloy M stored inside the molten metal reception portion 11 and the height of the inner circumferential surface 21a of the casting mold 12 on the upward side is preferably 0 mm to 250 mm (more preferably 50 mm to 170 mm). Within such a range, the pressure of the molten aluminum alloy M supplied to the inside of the casting mold 12 is favorably balanced with the lubricating oil and vaporized gas of the lubricating oil so that castability is made stable.

A vegetable oil (lubricating oil) can be used as the liquid lubricant. Examples thereof include rapeseed oil, castor oil, and cooking oil. These are preferable because they have a small adverse effect on the environment.

The amount of supply of the lubricating oil is preferably 0.05 mL/min to 5 mL/min (more preferably 0.1 mL/min to 1 mL/min). If the amount of supply is excessively small, there is concern that the molten aluminum alloy M of the aluminum alloy rod B may not solidify due to insufficient lubrication and leak from the casting mold 12. If the amount of supply is excessively large, there is concern that the excess may be mixed into the aluminum alloy rod B and cause internal defects.

The casting speed, which is a speed at which the aluminum alloy rod B is pulled from the casting mold 12, is preferably 200 mm/min to 1,500 mm/min (more preferably 400 mm/min to 1,000 mm/min). This is because, if the casting speed is within this range, the network structure of the crystallized products formed by casting becomes uniform and fine so that the resistance of an aluminum matrix with respect to deformation at a high temperature increases and high-temperature mechanical strength is improved.

The amount of cooling water injected through the shower opening 25a of the cooling water injection passage 25 is preferably 10 L/min to 50 L/min (more preferably 25 L/min to 40 L/min) per casting mold. The amount of cooling water is smaller than this, there is concern that the molten aluminum alloy M may not solidify and leak from the casting mold 12. In addition, there is concern that the surface of the cast aluminum alloy rod B may melt again and a non-uniform structure may be formed and remain as internal defects. Meanwhile, when the amount of cooling water is larger than this range, there is concern that coagulation may occur in the middle of the process due to excessively large heat release from the casting mold 12.

The average temperature of the molten aluminum alloy M flowing into the casting mold 12 from the inside of the molten metal reception portion 11 is preferably 650 °C to 750 °C (more preferably 680 °C to 720 °C), for example. If the temperature of the molten aluminum alloy M is excessively low, there is concern that coarse crystallized products may be formed in the casting mold 12 and in front of it and they may be incorporated into the aluminum alloy rod B as internal defects. Meanwhile, if the temperature of the molten aluminum alloy M is excessively high, there is concern that a large amount of hydrogen gas is likely to be incorporated into the molten aluminum alloy M and it may be incorporated into the aluminum alloy rod B as porosity and become cavities.

Further, in the cooling wall portion 27 of the casting mold 12, by setting the heat flux value per unit area from the molten aluminum alloy M in the hollow portion 21 toward the cooling water W in the cooling water cavity 24 within a range of 10×10⁵ W/m² to 50×10⁵ W/m², occurrence of seizing of the aluminum alloy rod B can be prevented.

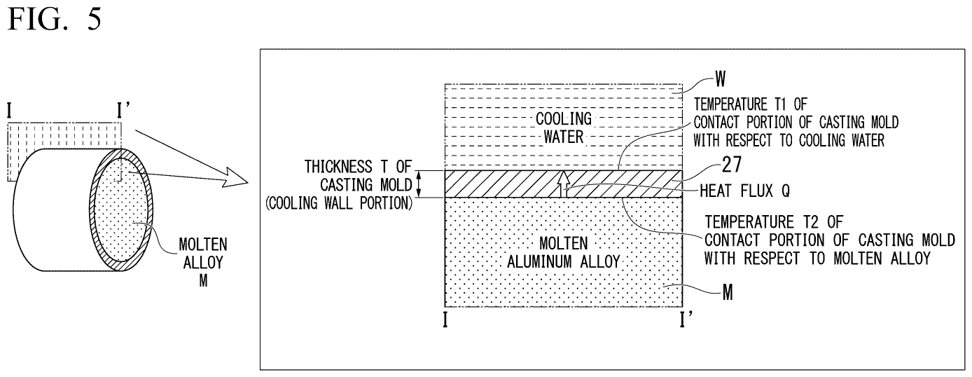

The cooling wall portion 27 of the casting mold 12 receives heat due to heat release from the molten aluminum alloy M and performs heat exchange by cooling this heat with the cooling water W accommodated in the cooling water cavity 24. Regarding the state of this heat exchange, as in the explanatory diagram shown in FIG. 5, attention was focused on the heat flux per unit area. The heat flux per unit area is expressed by the following expression (1) Fourier's law.

Q=−k×(T1−T2)/L (1)
Q: Heat flux
k: Thermal conductivity (W/m·K) of a portion passing through heat (in the present embodiment, the cooling wall portion 27 of the casting mold 12)
T1: Temperature on the low-temperature side of a portion passing through heat (in the present embodiment, the inner bottom surface 24a of the cooling water cavity 24)
T2: Temperature on the high-temperature side of a portion passing through heat (in the present embodiment, the inner circumferential surface 21a of the hollow portion 21 of the casting mold 12)
L: Length (mm) of a section of a portion passing through heat (in the present embodiment, the thickness t of the cooling wall portion 27 of the casting mold 12)

On the basis of the casting mold material, the thickness, and temperature measurement data with which favorable results could be obtained even if the amount of lubricating oil was reduced during casting, seizing of the cast aluminum alloy rod B can be prevented by constituting the cooling wall portion 27 of the casting mold 12 such that the heat flux value per unit area becomes 10×10⁵ W/m² or larger. In addition, it is preferable that the heat flux value per unit area be 50×10⁵ W/m² or smaller.

In order to set the heat flux value of the cooling wall portion 27 of the casting mold 12 within such a range, the casting mold 12 may be formed such that the thickness t of the cooling wall portion 27 of the casting mold 12 is within a range of 0.5 mm to 3.0 mm, for example. In addition, the thermal conductivity of at least the cooling wall portion 27 of the casting mold 12 may be set within a range of 100 W/m·K to 400 W/m·K.

When the aluminum alloy rod B of the present embodiment is manufactured, the molten aluminum alloy M stored inside the molten metal reception portion 11 is continuously supplied from the one end side 12a of the casting mold 12 to the inside of the hollow portion 21 using the horizontal continuous casting apparatus 10 described above. In addition, the cooling water W is supplied to the cooling water cavity 24, and a lubricating fluid, for example, a lubricating oil is supplied through the fluid supply pipe 22.

Further, the aluminum alloy rod B is cast by cooling and coagulating the molten aluminum alloy M supplied to the inside of the hollow portion 21 under conditions in which the heat flux value per unit area in the cooling wall portion 27 is 10×10⁵ W/m² or larger. In addition, when the aluminum alloy rod B is cast, it is preferable to set the wall surface temperature of the cooling wall portion 27 of the casting mold 12 cooled by the cooling water W to 100 °C or lower.

The aluminum alloy rod B obtained in this manner is cooled and coagulated under conditions in which the heat flux value per unit area in the cooling wall portion 27 is 10×10⁵ W/m² or larger, thereby curbing adhesion of reaction products, for example, carbides caused by contact between gas of the lubricating oil and the molten aluminum alloy M. Accordingly, there is no need to cut and remove carbides or the like on the surface of the aluminum alloy rod B, and therefore the aluminum alloy rod B can be manufactured with a high yield.

The casting step of obtaining a cast product from the molten aluminum alloy M is not limited to the horizontal continuous casting method described above, and a known continuous casting method such as the vertical continuous casting method can be used. The vertical continuous casting method is classified into a float method or a hot top method depending on the method for supplying the molten aluminum alloy M to the mold (casting mold 12). However, a case of using the hot top method will be simply described below.

The casting apparatus used in the hot top method includes a mold, a molten metal receptacle (header), and the like. A molten metal supplied to the molten metal reception portion passes through a tapping port and passes through the header, in which the flow rate is adjusted, and it enters the tubular casting mold which has been installed almost horizontally. The molten metal is forcibly cooled therein, and a coagulated shell is formed on the outer surface of the molten metal.

Moreover, the cooling water is directly sprayed onto the cast product taken out from the casting mold, and the cast product is continuously drawn out while coagulation of the metal proceeds the inside of the cast product. Generally, a metal member having good thermal conductivity is used for the mold, which has a hollow structure for introducing a coolant therein.

The coolant to be used may be suitably selected from among those which are industrially available, and water is recommended from the viewpoint of usability.

The mold used in the present embodiment is suitably selected from a metal, such as copper or aluminum, or graphite from the viewpoint of heat transfer performance and durability in a contact portion with respect to the molten metal. The header is generally made of a refractory material and is installed on the upward side of the mold. The material and the size of the header are not particularly restricted and may be suitably selected depending on the component range of the alloy to be cast or the dimensions of the cast product.

For example, the average cooling rate during casting may be suitably selected from a generally recommended range, such as 10 to 300 °C/sec. The casting speed may be suitably selected from a general range for horizontal continuous casting. For example, it may be suitably selected from a range of 200 to 600 mm/min.

In the casting method described above, the diameter of a target cast product is not particularly limited, and the method is favorably used for rod materials having a diameter of 30 to 100 mm.

### (Homogenization Heat Treatment Step)

A homogenization heat treatment step is a step of performing homogenization of micro-segregations caused by coagulation, precipitation of supersaturation solid solution element, and change of the metastable phase to an equilibrium phase by performing homogenization heat treatment with respect to an aluminum alloy cast product obtained in the casting step.

In the present embodiment, homogenization heat treatment in which an aluminum alloy cast product obtained in the casting step is held at a temperature of 370 °C to 560 °C or lower for four to ten hours may be performed, or homogenization heat treatment may be omitted. By performing homogenization heat treatment within this temperature range, the aluminum alloy cast product is homogenized and solute atoms are sufficiently infiltrated. For this reason, the required strength can be enhanced by the subsequent aging treatment. When homogenization heat treatment is performed, an aluminum alloy cast product is heated and then cooled. For example, an aluminum alloy forged product is cooled to room temperature.

### (Forging Step)

The forging step is a step of obtaining a forging material by molding an aluminum alloy cast product after casting or after the homogenization heat treatment step into a predetermined size, heating the obtained forging material at a predetermined temperature, and then molding it using a mold by applying a pressure with a press machine.

The in-plane average grain size of the forging material is preferably 100 μm or smaller and is more preferably 80 μm or smaller. The in-plane average grain size of the forging material is 30 μm or larger, for example.

In the present embodiment, a forged product (for example, an automobile suspension arm member or the like) is obtained by performing forging with respect to a forging material at a heating temperature of 470 °C to 500 °C. For example, in the forging step, forging is performed after being held (heated) at the foregoing heating temperature (material heating temperature) for 40 minutes or longer, preferably for 60 minutes to three hours. The characteristics of the forged product can be made stable by performing forging with respect to the forging material within the foregoing temperature range. If the temperature of the forging material at the time of starting forging is lower than 470 °C, there is concern that abnormal recrystallization may be promoted in the solution treatment step after forging, causing deterioration in strength. In addition, if the temperature exceeds 500 °C, there is concern that recrystallization may be promoted in the process up to dissolution treatment due to the influence of heat generated during forging, also causing deterioration in strength. In addition, if the starting temperature of forging of a forging material is excessively low, the deformation resistance will increase and sufficient processing will not be able to be performed, and if it is excessively high, defects such as forging cracking or eutectic melting will be likely to occur. Therefore, it is preferable to start forging of the forging material at the foregoing temperature. It is preferable to heat the mold to curb a temperature fall in the forging material during forging. The heating temperature of the cast product in the forging step may be 480 °C. or higher or 490 °C or lower.

As shown in Examples and Comparative Examples, there is a correlation between the half value width in the diffraction peak of a Debye ring obtained by performing X-ray diffraction and the 0.2% yield strength. When the half value width is large, it means that variation between aluminum crystal lattices is large. The variation between crystal lattices increases as the dislocation density between the crystal lattices increases. The dislocation density has a correlation with the strength. In the present embodiment, by deliberately setting the half value width within a range as described above, the 0.2% yield strength can be stably increased even when recrystallization is exhibited.

### (Solution Treatment Step)

The solution treatment step is a step of heating and solutionizing a forged product obtained in the forging step to alleviate the strain introduced into a cast product for a solid solution of solute elements.

In the present embodiment, the solution treatment is performed by holding a forged product at a treatment temperature of 530 °C to 560 °C for 0.3 hours to four hours, for example. The solution treatment is preferably performed by holding it at a treatment temperature of 550 °C or lower for 1.5 hours to three hours. The temperature rising rate from room temperature to the treatment temperature described above is preferably 5.0 °C/min or higher. If the treatment temperature is lower than 530 °C, there is concern that the solid solution of the solute elements may become insufficient. Meanwhile, if the treatment temperature exceeds 560 °C, the solid solution of the solute elements may be further promoted, but there is concern that eutectic melting or the recrystallization may be likely to occur. In addition, when the temperature rising rate is lower than 5.0 °C/min, coarse precipitation of Mg₂Si may occur, and therefore the temperature rising rate is preferably 5.0 °C/min or higher as described above. Meanwhile, when the treatment temperature is lower than 530 °C, there is concern that solutionizing may not proceed, making it difficult to realize a high strength by aging precipitation.

### (Quenching Treatment Step)

The quenching treatment step is a step of forming a supersaturated solid solution by quickly cooling a forged product in a solid solution state obtained in the solution treatment step.

In the present embodiment, quenching treatment is performed by inputting a forged product to a water tank storing water (quenching water) such that the forged product is submerged. The water temperature inside the water tank is preferably 20 °C to 60 °C. It is preferable that the forged product be input to the water tank after the solution treatment such that the entire surface of the forged product comes into contact with water for 5 seconds to 60 seconds. The submergence time of the forged product varies depending on the size of the cast product, and it is within 40 minutes exceeding 5 minutes, for example.

### (Aging Treatment Step)

The aging treatment step is a step of imparting an appropriate hardness by heating and holding a forged product at a relatively low temperature and precipitating supersaturated solid-solution elements.

In the present embodiment, aging treatment is performed by heating a forged product after the quenching treatment step at a temperature of 170 °C to 220 °C and holding it at the temperature for 0.5 hours to 7.0 hours. Preferably, aging treatment is performed by heating it at a temperature of 175 °C to 190 °C and holding it at the temperature for four hours or longer. If the heating temperature is lower than 170 °C or the holding time is shorter than 0.5 hours, there is concern that Mg₂Si-based precipitates for improving the tensile strength may not be able to grow sufficiently. Meanwhile, if the treatment temperature exceeds 220 °C, there is concern that Mg₂Si-based precipitates may coarsen excessively, that is, coarse Mg₂Si-based precipitates may be formed, and therefore the tensile strength may not be able to be sufficiently improved.

According to the method for manufacturing a suspension arm member of the present embodiment, it is possible to manufacture the suspension arm member according to the foregoing embodiment. According to the foregoing embodiment, it is possible to provide a high-strength suspension arm member having stable characteristics even if it exhibits a recrystallized structure.

Each of the upper limit values and/or the lower limit values of the numerical ranges described in this specification can be combined in any manner to stipulate a preferable range. For example, the upper limit values and the lower limit values of the numerical ranges can be combined in any manner to stipulate a preferable range. The upper limit values of the numerical ranges can be combined in any manner to stipulate a preferable range. In addition, the lower limit values of the numerical ranges can be combined in any manner to stipulate a preferable range.

Throughout the entirety of the present disclosure, the singular-term expressions should be understood to include its plural concept unless otherwise stated. Therefore, the singular articles (for example, “a”, “an”, “the”, and the like in English) should be understood to include its plural concept unless otherwise stated.

### EXAMPLES

Hereinafter, effects of the present invention will be made clearer by Examples. The present invention is not limited to the following Examples and can be suitably changed and performed within a range not changing the gist thereof.

### Example 1

First, a molten aluminum alloy having the following alloy composition was prepared.

Cu: 0.33 mass %, Mg: 1.02 mass %, Si: 0.73 mass %, Mn: 0.11 mass %, Fe: 0.24 mass %, Cr: 0.22 mass %, Ti: 0.023 mass %, B: 0.0026 mass %, and Al: remainder

The prepared molten aluminum alloy was used as a raw material, and a continuous casting rod of 200 L having a diameter of 78 mm and a circular cross section was produced using a horizontal-type continuous casting apparatus as described above.

The continuous casting rod was molded to have a size fitting the mold in the forging step and obtain forging materials. After the obtained forging material was heated at a heating temperature (material heating temperature) of 470 °C for one hour, a forged product was obtained by performing forging. The temperature of the mold used at this time was set to 200 °C. The average crystal grain size (average line segment length per crystal) of the forging material was measured using JIS G 0551:2020 Appendix A A.2 (cutting method) and was found to be 65 μm.

Next, solution treatment was performed with respect to the obtained forged product under the following conditions.
Temperature rising rate: 10 °C/min, temperature: 530 °C, holding time: three hours
Next, the water quenching step was performed under the following conditions.
Quenching water temperature: 40 °C.
Time from solution treatment to quenching: 10 seconds
Submergence time of forged product: 10 minutes

Next, the aging treatment step was performed under the following conditions.
Temperature: 180 °C, holding time: 6 hours

The A-shaped suspension arm member of Example 1 was produced by the foregoing method.

### Example 2

An A-shaped suspension arm member was produced by a method similar to that of Example 1 except that the heating temperature of the forging material in the forging step was changed to 480 °C.

### Example 3

An A-shaped suspension arm member was produced by a method similar to that of Example 1 except that the heating temperature of the forging material in the forging step was changed to 500 °C.

### Comparative Example 1

An A-shaped suspension arm member was produced by a method similar to that of Example 1 except that the heating temperature of the forging material in the forging step was changed to 520 °C.

### Comparative Example 2

An A-shaped suspension arm member was produced by a method similar to that of Example 1 except that the heating temperature of the forging material in the forging step was changed to 510 °C.

### Comparative Example 3

An A-shaped suspension arm member was produced by a method similar to that of Example 1 except that the heating temperature of the forging material in the forging step was changed to 450 °C.

### (X-Ray Diffraction)

In the A-type suspension arm members which are the polycrystalline metal materials of Examples 1 to 3 and Comparative Examples 1 to 3, X-ray diffraction was performed with respect to the position corresponding to the region R in FIG. 2. That is, X-ray diffraction was performed with respect to a part of an outer circumferential portion of a cross section passing through the middle point of a long arm portion in the axial direction in the arm portion connecting a wheel-side joint portion and a vehicle body-side joint portion which was a region with the highest processing rate. This part was a part having a processing rate exceeding 80%, specifically 85%.

The conditions for X-ray diffraction are as follows.
X-ray diffraction device: μ-x360s manufactured by Pulstec Industrial Co., Ltd.
X-ray incidence angle: 28.8 degrees
X-ray tube current: 1 mA
X-ray tube voltage: 30 kV
Distance between measurement device and sample: 50 mm
Aluminum diffraction plane: 311 plane, 222 plane
Tubular bulb: Co tubular bulb
X-ray tube wavelength Kα: 1.79021 Å
X-ray tube wavelength Kβ: 1.62075 Å

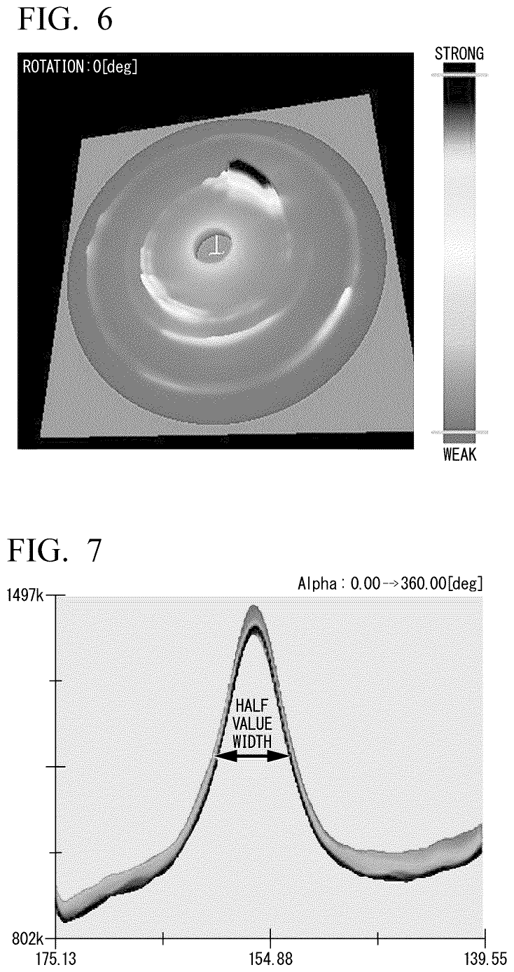

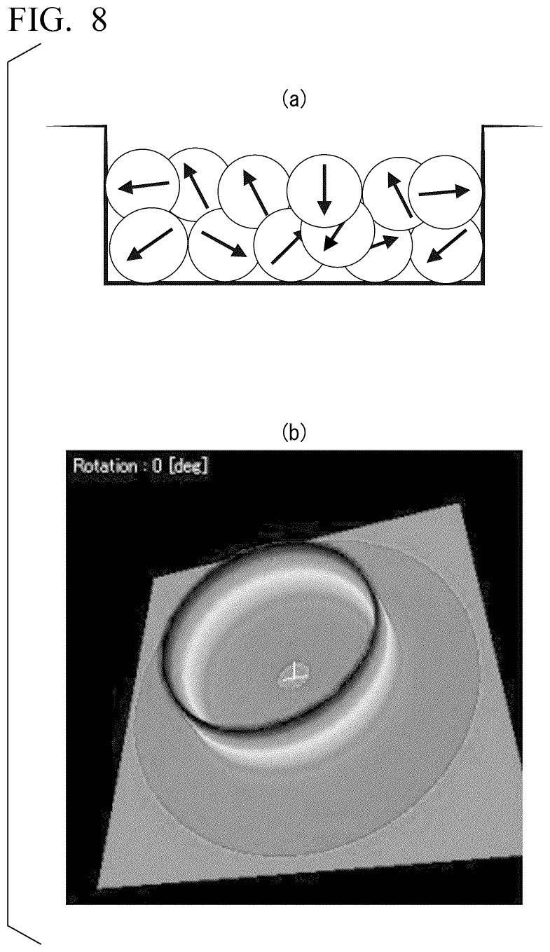

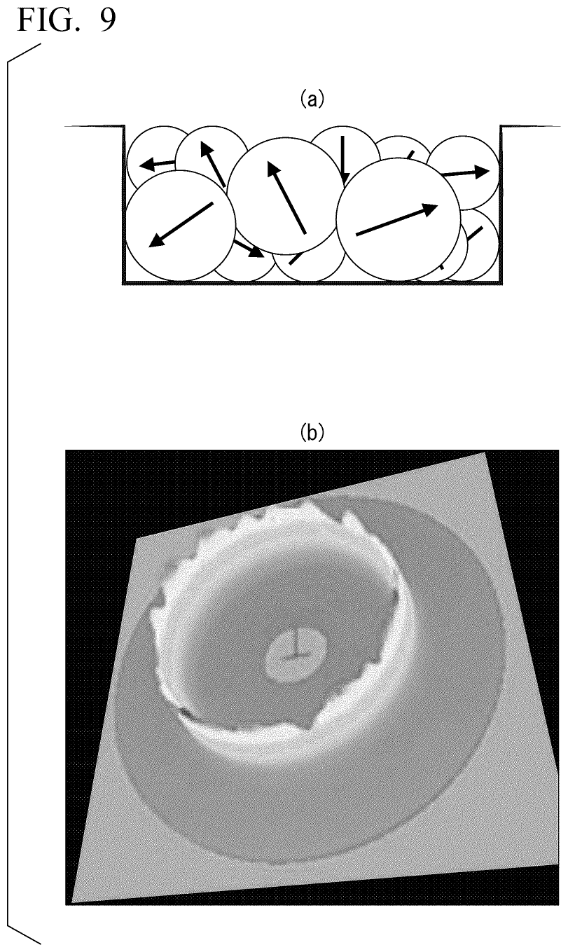

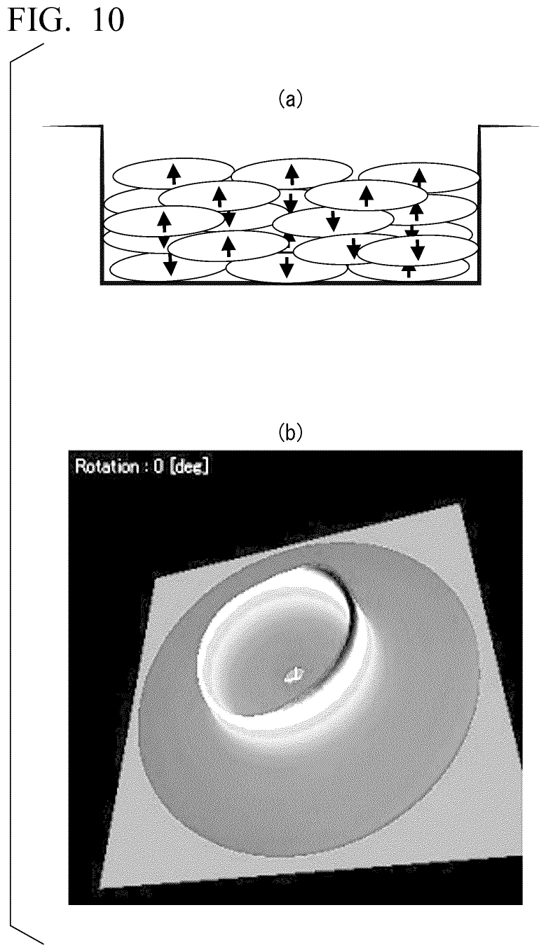

FIG. 6 is an X-ray diffraction result with respect to a first arm portion of the suspension arm member in Example 1. As shown in FIG. 6, a Debye ring of a polycrystalline metal material constituting the suspension arm member of Example 1 could not be obtained in a well-shaped manner. From this, in Example 1, it was considered that the cause was that some of crystals were coarse due to recrystallization. FIG. 7 shows analysis results of the diffraction intensity in the vicinity of the diffraction peak of a Debye ring in the X-ray diffraction result of FIG. 6. From the analysis results shown in FIG. 7, its half value width was 1.587 (degree).

X-ray diffraction was performed with respect to the suspension arm members of Example 2, Example 3, and Comparative Examples 1 to 3 by a method similar to that of Example 1. In all the samples, a well-shaped Debye ring could not be obtained, but the diffraction peak was confirmed. The half value width was measured with respect to these samples based on the analysis results of the diffraction intensity.

### (0.2% Yield Strength)

Tensile test specimens were collected from the suspension arm members of Examples 1 to 3 and Comparative Examples 1 to 3, and a tensile test was performed by a method conforming to JIS Z 2241:2011.

Regarding the tensile test specimens, test specimens having a longitudinal direction in the axial direction of the arm portion were collected from the middle point of a long arm portion in the axial direction in a recessed portion of the arm portion connecting the wheel-side joint portion and the vehicle body-side joint portion of the suspension arm member.

Table 1 summarizes the conditions for the forging step (material heating temperature and material heating time) when the aluminum alloy forging members of Examples 1 to 3 and Comparative Examples 1 to 3 are produced, the half value widths of the diffraction peaks of the obtained samples, and the results of the 0.2% yield strengths.

TABLE 1

| | Material | Material | | |
|---|---|---|---|---|
| | heating | heating | | |
| | temperature | time | Half | 0.2% |
| | during | during | value | yield |
| | forging | forging | width | strength |
| | [°C] | [hrs.] | [degree] | [MPa] |
| Example 1 | 470 | 1 | 1.587 | 304.9 |
| Example 2 | 480 | 1 | 1.607 | 304.8 |
| Example 3 | 500 | 1 | 1.603 | 302.7 |
| Comparative | 520 | 1 | 1.567 | 291.1 |
| Example 1 | | | | |
| Comparative | 510 | 1 | 1.507 | 286.4 |
| Example 2 | | | | |
| Comparative | 450 | 1 | 1.467 | 288.4 |
| Example 3 | | | | |

As shown in Table 1, the half value width of the diffraction peak in X-ray diffraction varied depending on the temperature in the forging step. In addition, it was confirmed that the half value width indicated the correlation with the 0.2% yield strength. In Examples 1 to 3, the half value width was a value within a range of 1.580° to 1.610°. The correlation was found first by the inventors. As described above, in all Examples 1 to 3 and Comparative Examples 1 to 3, a well-shaped Debye ring could not be obtained, and a recrystallized structure was exhibited. However, according to the present invention, it was confirmed that a suspension arm member having stable characteristics indicating a high 0.2% yield strength could be provided.

### REFERENCE SIGNS LIST

1 First arm portion
2 Second arm portion
3 Arm joint portion
4 Wheel-side joint portion
5 First vehicle body-side joint portion
6 Second vehicle body-side joint portion
7 Outer circumferential portion
8 Inner circumferential portion
9 Recessed portion
10 Horizontal continuous casting apparatus
11 Molten metal reception portion (tundish)
11a Molten metal inflow portion
11b Molten metal holding portion
11c Outflow portion
12 Casting mold
12a One end side
12b The other end side
13 Refractory material plate body (heat insulating member)
13a Pouring passage
21 Hollow portion
21a Inner circumferential surface
21b The other end side
22 Fluid supply pipe
22a Lubricant supply port
23 Cooling device
24 Cooling water cavity
24a Inner bottom surface
25 Cooling water injection passage
25a Shower opening
26 Cooling water supply pipe
27 Cooling wall portion
100 Suspension arm member
B Aluminum alloy rod
C Casting mold center axis (center axis)
M Molten aluminum alloy
P Particle
PDA-5500 Manufactured by Shimadzu Corporation, Japan
R Region
Si Primary crystal
W Cooling water
X Incidence
μ-x360s Manufactured by Pulstec Industrial Co., Ltd.

1. A suspension arm member made of an aluminum alloy having an alloy composition containing
Cu within a range of 0.2 mass % to 0.4 mass %,
Mg within a range of 0.9 mass % to 1.2 mass %,
Si within a range of 0.6 mass % to 0.9 mass %,
Mn within a range of 0.05 mass % to 0.15 mass %,
Fe within a range of 0.15 mass % to 0.30 mass %,
Cr within a range of 0.2 mass % to 0.35 mass %,
Ti within a range of 0.01 mass % to 0.05 mass %, and
B within a range of 0.0010 mass % to 0.0050 mass %,
with a remainder consisting of Al and inevitable impurities,
wherein a half value width in a diffraction peak of a Debye ring obtained by performing X-ray diffraction is 1.58° or larger.

2. The suspension arm member according to claim 1 comprising:
a wheel-side joint portion;
a first vehicle body-side joint portion;
a second vehicle body-side joint portion;
a first arm portion connecting the wheel-side joint portion and the first vehicle body-side joint portion; and
a second arm portion connecting the wheel-side joint portion and the second vehicle body-side joint portion,
wherein the first arm portion is longer than the second arm portion,
the half value width is a half value width of a diffraction peak of a Debye ring obtained by performing X-ray diffraction with respect to the first arm portion, and
a 0.2% yield strength is 300 MPa or greater.

3. A method for manufacturing a suspension arm member comprising:
a molten metal forming step of obtaining a molten alloy having an alloy composition containing
Cu within a range of 0.2 mass % to 0.4 mass %,
Mg within a range of 0.9 mass % to 1.2 mass %,
Si within a range of 0.6 mass % to 0.9 mass %,
Mn within a range of 0.05 mass % to 0.15 mass %,
Fe within a range of 0.15 mass % to 0.30 mass %,
Cr within a range of 0.2 mass % to 0.35 mass %,
Ti within a range of 0.01 mass % to 0.05 mass %, and
B within a range of 0.0010 mass % to 0.0050 mass %,
with a remainder consisting of Al and inevitable impurities;
a casting step of obtaining a cast product by casting the molten alloy;
a forging step of obtaining a forged product by forging the cast product at a temperature of 470 °C to 500 °C;
a solution treatment step of holding the forged product at a temperature of 500 °C or higher;
a water quenching step of performing water quenching of the forged product after solution treatment; and
an aging treatment step of performing heat treatment of a forged product that has gone through the water quenching step.

4. The method for manufacturing a suspension arm member according to claim 3,
wherein in the solution treatment step, the forged product is held at a temperature of 530 °C to 560 °C for 0.3 hours to three hours,
in the water quenching step, water quenching is performed using water at 60 °C or lower, and
in the aging treatment step, a forged product that has gone through the water quenching step is heated at a temperature of 170 °C to 220 °C for 0.5 hours to 7.0 hours.

5. The method for manufacturing a suspension arm member according to claim 4,
wherein the casting step is performed by continuous casting, and
in the aging treatment step, a forged product that has gone through the water quenching step is heated at a temperature of 175 °C to 190 °C for four hours or longer.
